(19) United States
(12) Patent Application Publication
(10) Pub. No.: US 2016/0103266 A1
(43) Pub. Date: Apr. 14, 2016

(54) ASYMMETRICAL LIGHT-TURNING FEATURES

(71) Applicant: QUALCOMM MEMS Technologies, Inc., San Diego, CA (US)

(72) Inventors: Zhengwu Li, Milpitas, CA (US); Shen-Ge Wang, Milpitas, CA (US); Jian Ma, Carlsbad, CA (US); John Hyunchul Hong, San Clemente, CA (US)

(21) Appl. No.: 14/513,977

(22) Filed: Oct. 14, 2014

(51) Int. Cl. F21V 8/00; G06F 3/042; G02B 26/08; G02B 1/11; G02B 26/00

(52) U.S. Cl. CPC G02B 6/0036; G02B 1/11; G02B 26/001; G02B 26/0833; G06F 3/0421; G06F 2203/04103

(57) ABSTRACT

This disclosure provides systems, methods and apparatus for light-guiding layers including asymmetrical light-turning features. In one aspect, the asymmetrical light-turning features may include a leading edge oriented at an angle which turns light out of the light-guiding layer, and a near-vertical trailing edge which reduces light leakage from the light-guiding layer. In another aspect, the asymmetrical light-turning features of the light-guiding layer may be oriented in the same or similar direction, and may be distributed with decreasing density adjacent a light source to provide more even illumination.

### TECHNICAL FIELD

This disclosure relates to frontlight systems, and in particular frontlight systems which can be used alone or in conjunction with reflective displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a light-turning structure comprising a substrate including a first generally planar surface and a second generally planar surface; and a plurality of depressions in the shape of asymmetrical frusta formed in the first surface of the substrate, each of the plurality of depressions having an angled sidewall including a leading edge forming a first angle relative to a normal of the first surface and configured to reflect a portion of incident light out of the substrate, and a trailing edge forming a second angle relative to the normal of the first surface, wherein the first angle is substantially larger than the second angle.

In some implementations, the first angle can be between 31° and 35°. In some implementations, the second angle can be between 1° and 5°. In some implementations, the plurality of depressions can have an ellipsoidal cross-section. In some implementations, each of the plurality of depressions can include an ellipsoidal opening in the first surface of the light substrate and an ellipsoidal base, wherein the ellipsoidal opening is non-concentric with the ellipsoidal base.

In some implementations, the substrate can include a first material, and the structure can additionally include a cladding layer formed over the first surface of the substrate, wherein the cladding layer is formed from a second material, and wherein the index of refraction of the first material is greater than the index of refraction of the second material.

In some implementations, the substrate can include a first edge, and the leading edges of the angled sidewalls of the plurality of depressions can be generally aligned to face the first edge of the substrate. In some further implementations, a density of the plurality of depressions can increase with increasing distance from the first edge of the substrate.

Another innovative aspect of the subject matter described in this disclosure can be implemented in a reflective display device, comprising an array of reflective display elements; and a frontlight system configured to illuminate the array of reflective display elements, the frontlight system including a light-guiding layer having a first edge, a first generally planar surface, and a second generally planar surface; a light source configured to inject light into the light-guiding layer through the first edge of the light-guiding layer; and a plurality of light-turning features in the shape of asymmetrical frusta formed in the first surface of the light-guiding layer and configured to reflect light out of the light-guiding layer through the second surface of the light-guiding layer and towards the array of reflective display elements.

In some implementations, each of the plurality of depressions can have an angled sidewall including a leading edge forming a first angle relative to a normal of the first surface of the light-guiding layer, and a trailing edge forming a second angle relative to the normal of the first surface, wherein the first angle is substantially larger than the second angle. In some implementations, the device can additionally include an array of touch sensors disposed on the opposite side of the second cladding layer as the light-guiding layer.

Another innovative aspect of the subject matter described in this disclosure can be implemented in a light-turning structure comprising a substrate including a first generally planar surface and a second generally planar surface; and means for reflecting a portion of incident light out of the substrate, wherein the amount of incident light reflected out of the substrate varies depending on the direction of incidence upon the reflecting means.

In some implementations, the reflecting means can include a plurality of depressions in the shape of asymmetrical frusta formed in the first surface of the substrate, each of the plurality of depressions having an angled sidewall including a leading edge forming a first angle relative to a normal of the first surface and configured to reflect a portion of incident light out of the substrate, and a trailing edge forming a second angle relative to the normal of the first surface, wherein the first angle is substantially larger than the second angle.

Another innovative aspect of the subject matter described in this disclosure can be implemented in a method of fabricating a light-turning structure, comprising embossing a plurality of depressions in the shape of asymmetrical frusta into a first generally planar surface of a substrate, the substrate including a first material having a first index of refraction; and applying a cladding layer over the first surface of the substrate after embossing the plurality of depressions into the substrate, the cladding layer including a second material having a second index of refraction smaller than the first index of refraction.

In some implementations, each of the depressions can have an angled sidewall including a leading edge forming a first angle relative to the normal of the first surface and configured to reflect a portion of incident light out of the substrate, and a trailing edge forming a second angle relative to the normal of the first surface, wherein the first angle is substantially larger than the second angle. In some implementations, embossing a plurality of depressions and applying a cladding layer can be performed as part of a roll-to-roll fabrication process. In some implementations, the method can additionally include depositing an antireflection coating over the embossed first surface of the substrate prior to application of the cladding layer.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a side cross-section of an example of a frontlight system configured to turn incident light out of plane of the device.

FIG. 1B shows a side cross-section of the frontlight system of FIG. 1A surrounded by cladding layers.

FIG. 2 is a detail cross-sectional view of a light-turning feature of a frontlight system, illustrating light leakage from the frontlight system.

FIG. 3A is a top plan view of a section of a light-guiding layer including an array of asymmetrical light-turning features in the form of asymmetrical frusta.

FIG. 3B is a detail cross-sectional view of one of the asymmetric light-turning features of the light-guiding layer of FIG. 3A, taken along the line 3B-3B of FIG. 3A.

FIG. 3C is a detail cross-sectional view of one of the asymmetric light-turning features of the light-guiding layer of FIG. 3A, taken along the line 3C-3C of FIG. 3A.

FIG. 3D is a perspective view of the section of light-guiding layer of FIG. 3A.

FIG. 4 is a top plan view of a frontlight system in which the density of the asymmetrical frusta varies with increased distance from a light source.

FIG. 5 is a cross-sectional view of a display device including a frontlight system which includes asymmetrical light-turning features.

FIG. 6 is a cross-sectional view of an alternate implementation of a display device including a frontlight system which includes asymmetrical light-turning features.

FIGS. 7A-7D illustrate various stages in a fabrication process for forming a multilayer structure including asymmetrical light-turning features.

FIG. 8 is a flow diagram illustrating a fabrication process for a multilayer structure including asymmetrical light-turning features.

FIG. 9 is an isometric view illustration depicting two adjacent interferometric modulator (IMOD) display elements in a series or array of display elements of an IMOD display device.

FIGS. 10A and 10B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In order to illuminate a reflective display or other object, a frontlight system can be disposed over the object to be illuminated. Light can be injected from the side of the frontlight system and into a light-guiding film. The light can propagate within the light-guiding film until it strikes a light-turning feature and is reflected downward and out of the light-guiding film to illuminate the underlying object. In some implementations, these light-turning features may include angled surfaces with a reflective coating, but the formation of such reflective coatings can increase the cost and complexity of the fabrication process. In other implementations, the light-guiding film can be formed from a material which has a higher index of refraction than the overlying material, and light-turning features may instead utilize total internal reflection (TIR) to turn light downwards and out of the light-guiding layer. However, because of the lack of reflective coating, some light may leak out of these light-turning features, rather than being reflected. By utilizing asymmetrical light-turning features, some of the leaked light can be recaptured, improving the operation of the frontlight system.

Particular implementations of the subject matter described in this disclosure can be implemented to realize one or more of the following potential advantages. In implementations in which asymmetrical frusta are used as light-turning features in a frontlight system used with a reflective display, the reduced light leakage can improve the contrast ratio of the display. Such light-turning features can also be stamped or embossed in a plastic layer, and a multilayer frontlight system can be formed using inexpensive roll-to-roll fabrication processes. Such implementations can provide more efficient frontlight systems without the complexity and expense involved in forming a reflective coating over the light-turning features.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber. Other reflective display devices can include, for instance, reflective liquid crystal displays (LCDs) and e-ink displays.

In certain implementations, frontlight systems can be used to provide primary or supplemental illumination for a display device or other object to be illuminated. In particular, reflective display devices such as interferometric modulator-based devices or other electromechanical system (EMS) devices may utilize frontlight systems for illumination due to the opacity of the EMS devices. While a reflective display such as an interferometric modulator-based display may in some implementations be visible in ambient light, some particular implementations of reflective displays may include supplemental lighting in the form of a frontlight system,

In some implementations, a frontlight system may include one or more light-guiding films or layers through which light can propagate, and one or more light-turning features to direct light out of the light-guiding layers. Light can be injected into the light-guiding layer, and light-turning features can be used to reflect light within the light-guiding layer towards the reflective display and back through the light-guiding layer towards a viewer. Until light reaches a light-turning feature, the injected light may propagate within the light-guiding layer by means of total internal reflection so long as the material of the light-guiding layer has an index of refraction greater than that of the surrounding layers. Such a frontlight system allows an illuminating light source to be positioned at a location offset from the display or other object to be illuminated, such as at one of the edges of the frontlight system.

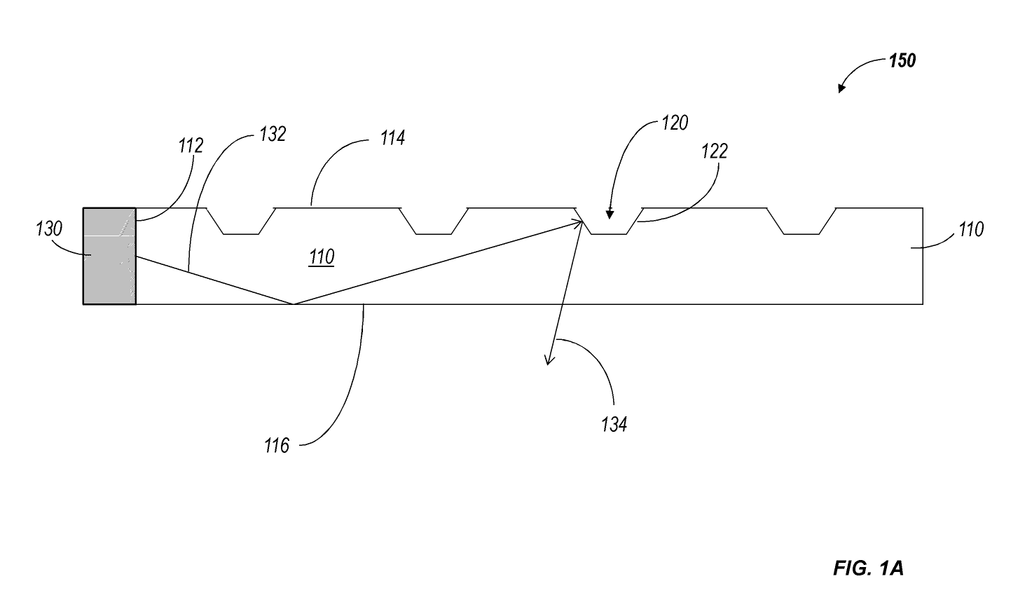

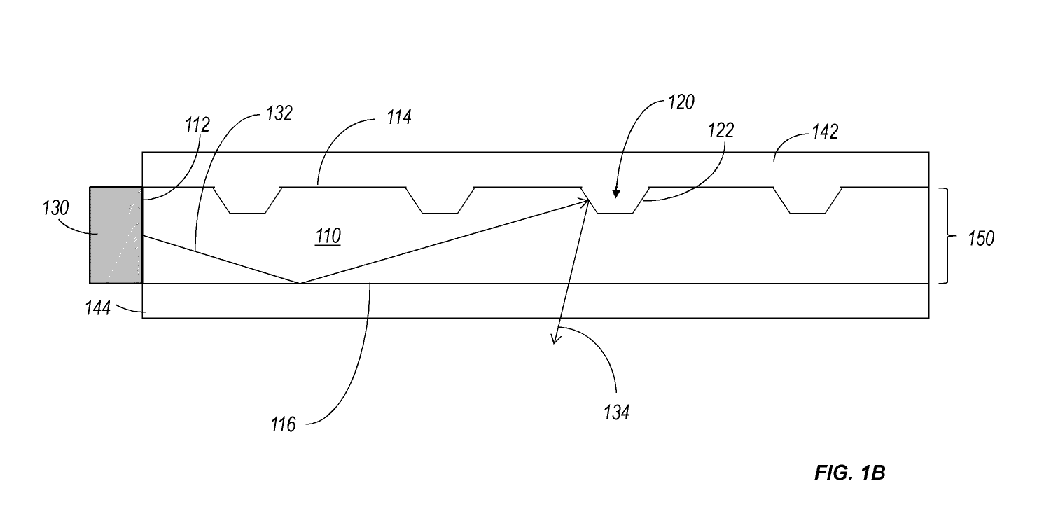

FIG. 1A shows a side cross-section of an example of a frontlight system configured to turn incident light out of plane of the device. The frontlight system 150 includes a light-guiding layer 110 which may have an index of refraction greater than air or any surrounding layers, as discussed above. The light-guiding layer 110 may also include a plurality of light-turning features 120 disposed along an upper surface 114 of the light-guiding layer 110. These light-turning features 120 include reflective surfaces 122 oriented at an angle to the upper surface 114 and lower surface 116 of light-guiding layer 110. The frontlight system 150 also includes one or more light sources such as LED 130 disposed adjacent an edge 112 of the light-guiding layer 110.

The LED 130 injects light 132 into the light-guiding layer 110, which propagates by means of total internal reflection as shown until it strikes a light-turning feature 120. The light 134 reflected off the light-turning feature 120 is turned downwards towards lower surface 116 of the light-guiding layer 110. When the light 134 is reflected at an angle sufficiently close to the normal of the lower surface 116 of light-guiding layer 110, the light 134 passes through the lower surface 116 of light-guiding layer 110 without being reflected back into the light-guiding layer 110.

Although referred to for convenience as a light-guiding layer 110, the light-guiding layer 110 may in some implementations be a multilayer structure formed from layers having indices of refraction sufficiently close to one another that the light-guiding layer 110 generally functions as a single film, with negligible or insignificant refraction and/or total internal reflection between the various sublayers of the light-guiding film layer.

The frontlight system 150 thus redirects light 132 propagating within the light-guiding layer 110 downward through the lower surface 116 of the front. As illustrated in FIG. 1A, the frontlight system 150 relies on the interface between the high-index material of light-guiding layer 110 and air to provide total internal reflection (TIR). However, a frontlight system is often used as part of a multilayer structure, and contact between the light-guiding layer 110 and another high-index material may frustrate the total internal reflection and prevent the frontlight system 150 from operating as intended.

FIG. 1B shows a side cross-section of the frontlight system of FIG. 1A surrounded by cladding layers. In some implementations, similar total internal reflection performance can be achieved by surrounding the light-guiding layer 110 with an upper cladding layer 142 and a lower cladding layer 144. The upper cladding layer 142 and lower cladding layer 144 can be formed from a material which has a lower index of refraction than the light-guiding layer 110. As can be seen in FIG. 1B, the upper cladding layer is formed over the upper surface 114 of the light-guiding layer 110 and fills the depressions of the light-turning features 120, forming an interface between the lower-index upper cladding layer 142 and the higher-index light-guiding layer 110 at the angled surfaces 122 of the light-turning features 120.

In some implementations, light-turning features may be coated with a reflective material, to ensure that all light incidents upon the light-turning features 120 is reflected. However, coating the light-turning features 120 generally requires a precise fabrication process, increasing the cost and complexity of the fabrication process. Even if the reflective layer is masked on the other side, the use of an opaque reflective material within a frontlight system can alter the appearance of the underlying display or object. The lack of an opaque reflective layer, however, will result in some light leakage when light strikes the angled surfaces 122 of the light-turning features 120 at an angle close to normal.

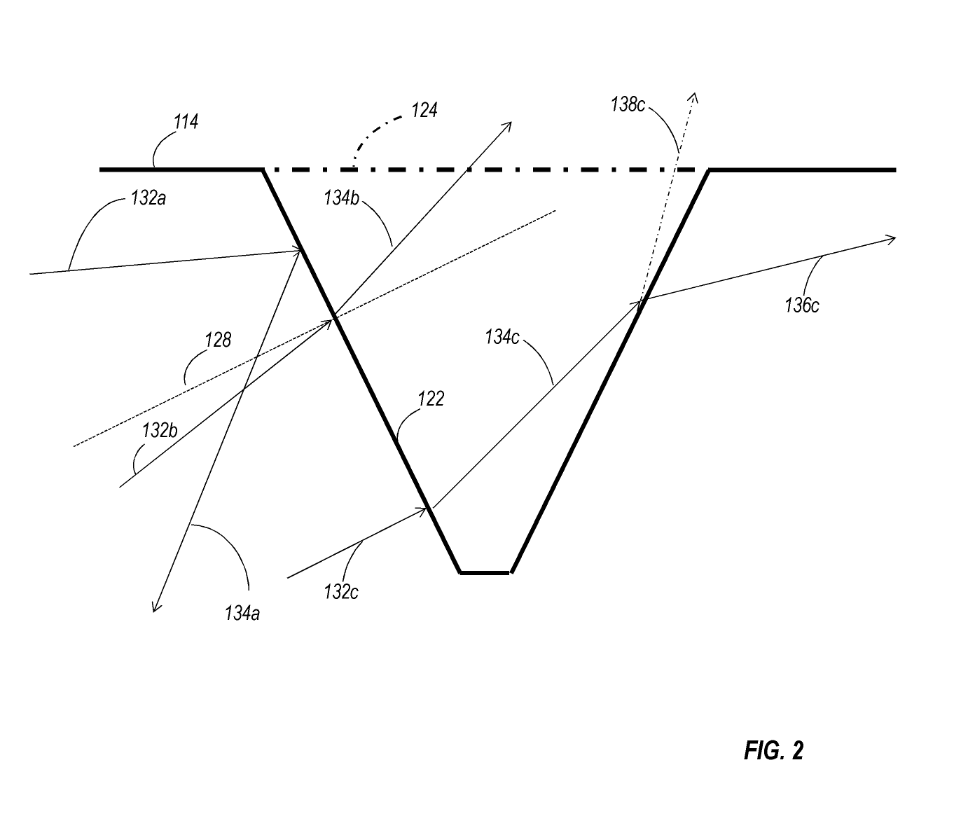

FIG. 2 is a detail cross-sectional view of a light-turning feature of a frontlight system, illustrating light leakage from the frontlight system. A first light ray 132a incident upon the angled surface 122 of the light-turning feature 120 is reflected downward as light 134a, and out of the light-guiding layer 110. A second light ray 132b incident upon the angled surface 122 of the light-turning feature 120 at an angle close to or parallel to the normal 128 of surface 122, however, does not undergo total internal reflection but instead passes through the open top 124 of the light-turning feature 120 as ray 134b, upwards and out of the light-guiding layer 110.

In addition to direct leakage of ray 134b, some leakage will occur when light passes through the light-turning feature 120 and is incident upon the opposing face of the light-turning feature 120. A third ray 132c is incident upon the angled surface 122 of the light-turning feature 120 at an angle sufficiently close to or parallel to the normal of surface 122 that the ray 132c passes through the surface 122 as ray 134c rather than undergoing total internal reflection. Unlike ray 134b, which passes through the open top 124 of light-turning feature 120, the ray 134c is incident upon the opposite side of the light turning feature 120 and a portion of the light of ray 134c passes into the light-guiding layer 110 and continues on as ray 136c, at a different angle than ray 134c due to refraction at the boundary of the light-turning feature 120. However, a portion of the light will be reflected due to Fresnel reflection at the boundary between two media with differing indices of refraction. Due to the angle of the sidewalls 122 of light-turning feature 120, the ray 138c which results from the Fresnel reflection will be directed generally upward and toward a viewer as shown. The relative amounts of the light of ray 134c which are refracted as ray 136c and reflected as ray 138c are described by the Fresnel equations, and are dependent upon the angle of incidence and the indices of refraction of the two media on either side of the boundary. The light leakage from the light-guiding layer 110, due both to direct light leakage and Fresnel reflection, will alter the visual appearance of the frontlight system and of the underlying display or object being illuminated, reducing the contrast ratio and possibly causing other visual artifacts.

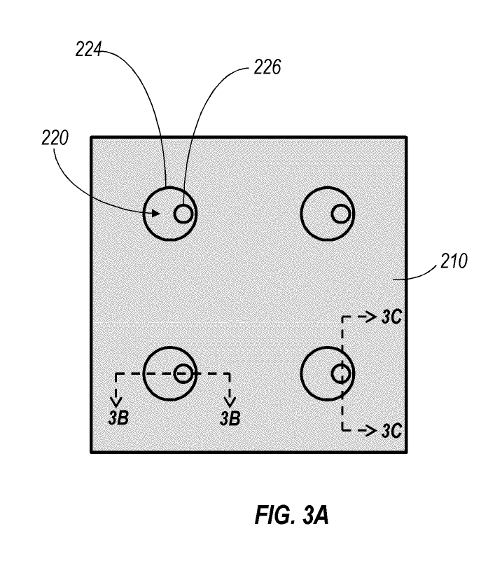

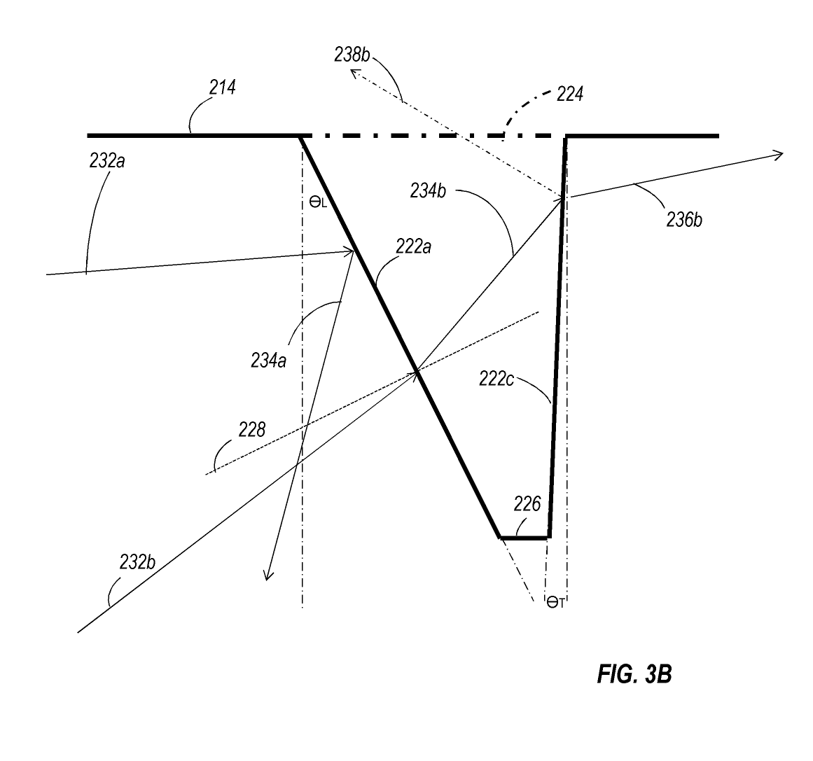

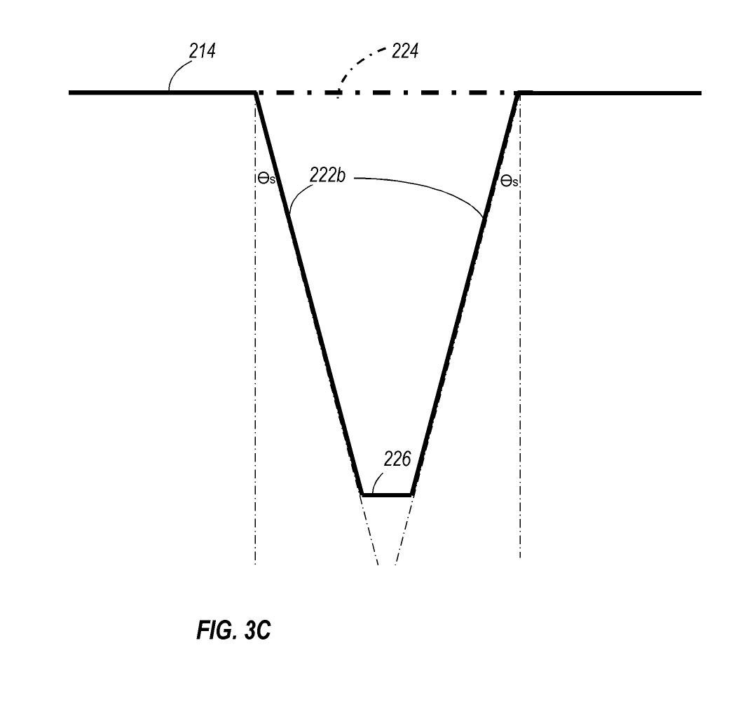

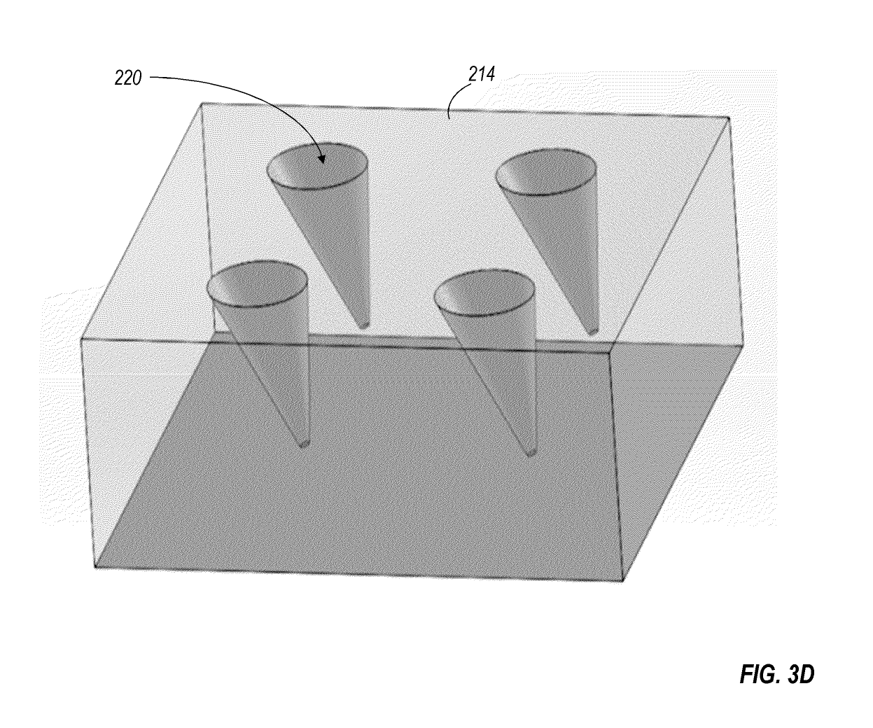

FIG. 3A is a top plan view of a section of a light-guiding layer including an array of asymmetrical light-turning features in the form of asymmetrical frusta. The light-guiding layer 210 includes a plurality of light-turning features 220 in the form of asymmetrical frusta having a base 226 which is non-concentric with the top 224 of the light-turning feature, such that one side of the base 226 is much closer to the adjacent edge of the top 224. In the illustrated implementation, both base 226 and top 224 are generally circular, but other shapes may also be used, such as ovals, ellipses, or any other suitable shape.

FIG. 3B is a detail cross-sectional view of one of the asymmetric light-turning features of the light-guiding layer of FIG. 3A, taken along the line 3B-3B of FIG. 3A. It can be seen in FIG. 3B that the leading edge 222a of the asymmetrical light-turning feature 220 makes an angle θ_{L} with the normal of the planar upper surface 214 of light-guiding layer 210 which is much larger than the angle θ_{T} that the trailing edge 222c makes with the normal of the planar upper surface. In some implementations, the leading angle θ_{L} may be roughly 33°, although in other implementations it may be between 31° and 35°, greater than 35°, or less than 31°. In some implementations the trailing edge 222c may be near vertical, and the trailing angle θ_{L} may be 3°, although in other implementations it may be between 1° and 5°, greater than 5°, or less than 1°. The top 224 of the asymmetrical light-turning feature 220 may in some implementations be roughly 15 um wide, and the base 226 of the asymmetrical light-turning feature 220 may in some implementations be roughly 5 um wide, although a wide variety of other shapes and a wide range of other sizes may be used in other implementations, and the relative sizes may be dependent on the leading angle θ_{L} and trailing angle θ_{T}.

Although the transitions between the upper planar surface 214 of the light-guiding layer 210 and the leading and trailing edges 222a and 222c of the light-guiding layer 210 are depicted as being sharp corners, there may be some curvature due to the stamping process or other fabrication process used to form the light-turning features 220. In some implementations, the curved portion may have a radius of less than 0.5 um, for a light-turning feature having dimensions similar to the exemplary dimensions discussed above.

By decreasing the size of trailing angle θ_{T}, the area of the top 224 of the asymmetrical light-turning feature 220 may be reduced without significantly altering the reflection of light incident upon the leading edge 222a of the asymmetrical light-turning feature 220. In doing so, some of the light which would otherwise leak out through the top 124 of the light-turning feature 120 of FIG. 2 can instead be recaptured and prevented from leaking out. In particular, light ray 232b incident upon the angled leading edge 222a of the light-turning feature 220 at an angle close to or parallel to the normal 228 of surface 222a, again does not undergo total internal reflection, passing through leading edge 222a of light-turning feature 220. Instead of passing upwards and completely out of the light-guiding layer 210 through the open top 224 of the light-turning feature 220, light ray 234b reenters light-guiding layer 210 through the near-vertical trailing edge 222c and is totally internally reflected by the upper layer 214 of light-guiding layer 210. This recaptured light continues to propagate through the light-guiding layer 210 as ray 236b.

Similarly, the near-vertical orientation of the trailing edge 222c can reduce the effect of Fresnel reflections on the optical appearance of a frontlight system. Light ray 232b is incident upon the leading edge 222a of the light-turning feature 220 at an angle sufficiently close to the normal of the leading edge 222a that a portion of the light ray 232b passes through and is refracted by the leading edge 222a as ray 234b. Ray 234b is incident upon the trailing edge 222c of the light-turning feature 220, and a portion of ray 234b passes through and is refracted at the trailing edge 222c of the light-turning feature 220. Another portion of ray 234b is reflected via Fresnel reflection as ray 238b. In contrast to ray 138c of FIG. 2, ray 234b is reflected at a shallower angle to the planar upper surface 214, due to the steeper angle of the trailing edge 222c of the light-turning feature 220. Because of the asymmetrical shape of light-turning features 220, the light reflected by Fresnel reflection is more likely to be directed to the side, and less likely to be directed at a viewer. Thus, the use of asymmetrical light-turning features 220 can reduce the optical effect generated by Fresnel reflection in addition to reducing direct light leakage as discussed above.

FIG. 3C is a detail cross-sectional view of one of the asymmetric light-turning features of the light-guiding layer of FIG. 3A, taken along the line 3C-3C of FIG. 3A. It can be seen in FIG. 3C that the side edges 222b of the light-turning feature 220 form an angle θ_{S} with the normal of the planar upper surface 214 of light-guiding layer 210 which is larger than the angle θ_{T} of the trailing edge 222c (see FIG. 3B) and smaller than the angle θ_{L} of the leading edge 222b (see FIG. 3B). Much of the propagating within the light-guiding layer 210 will travel in a direction close to parallel with the plane of the light-guiding layer 210, either directly from the light source to a light-turning feature 220, or in a zig-zag pattern as it reflects off of the upper planar surface 214 and the lower planar surface (not shown) of the light-guiding layer 210. The side edges 222b and the trailing edge 222c of the light-turning feature 220 will be less effective at turning light downward, as the normals of the side edges 222b and the trailing edge 222c are more closely aligned with the plane of the light-turning feature 220. Because of this, light incident upon the side edges 222b and the trailing edge 222c at wider range of angles will pass through the side edges 222b or the trailing edge 222c rather than being totally internally reflected and turned downward.

FIG. 3D is a perspective view of the light-guiding layer of FIG. 3A.

It can be seen in FIG. 3D that the asymmetrical light-turning features 220 are generally aligned to face one side of the light-guiding layer 210. The efficiency of a frontlight system using the light-guiding layer 210 with asymmetrical light-turning features 220 can be generally improved by injecting light from only the side of the light-guiding layer 210 which the leading edges of the asymmetrical light-turning features 220 are facing. Because most light injected into the light-guiding layer 210 will be incident upon the leading edge 222a of the light-turning features 220 of the, the comparative inefficiency of the side edges 222b and the trailing edge 222c of the light-turning feature 220 as light-turning surfaces will not significantly impact the light-turning properties of the light-guiding layer 210.

Depending on the size of the light source and the number of light sources used, the specific alignment of the light-turning features 220 can vary. In some implementations, the light-turning features 220 can all have the same orientation, with the portion of the leading edge 222a making the largest angle with the upper planar surface 214 of the light-guiding layer 210 being closest to the edge of the light-guiding layer 210 on which the light source is disposed. In some implementations in which the light source is a single light source extending along only a portion of the edge of the light-guiding layer 210, the light-turning features 220 can be partially or completely radially aligned with the light source, such that the portion of the leading edge 222a making the largest angle with the upper planar surface 214 of the light-guiding layer 210 is turned towards the light source itself.

The intensity of light incident upon a light-turning feature 220 is dependent upon the distance between the light-turning feature 220 and the light source. A light-turning feature closer to the light source will turn more light downward and provide more illumination to an underlying display or other object than an identical light-turning feature farther away from the light source. In order to achieve more uniform illumination, the density of light-turning features 220 can be increased with increased distance from the light source. For different sizes and shapes of light-guiding films, and for different sizes and shapes of light-turning features, appropriate arrangements of and spacing between light-turning features may be used to provide desired amounts and distribution of illumination. In addition, the exact locations of the frusta may be randomized somewhat in order to inhibit the formation of Moiré artifacts caused by periodic structures.

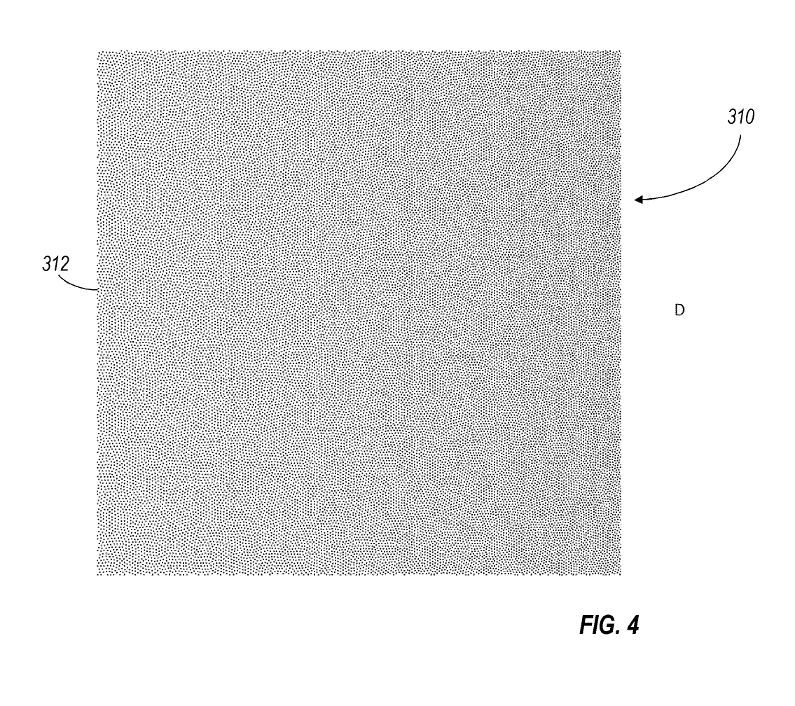

FIG. 4 is a top plan view of a frontlight system in which the density of the asymmetrical frusta varies with increased distance from a light source. The light-guiding layer 310 includes a large number of asymmetrical frusta, with the density of the frusta greater along the right side of the light-guiding layer 310. If a light source (not shown) is positioned along the left side of the light-guiding layer 310, a substantially even amount of light injected into the light-guiding layer 310 will be turned downward to illuminate an underlying display or object.

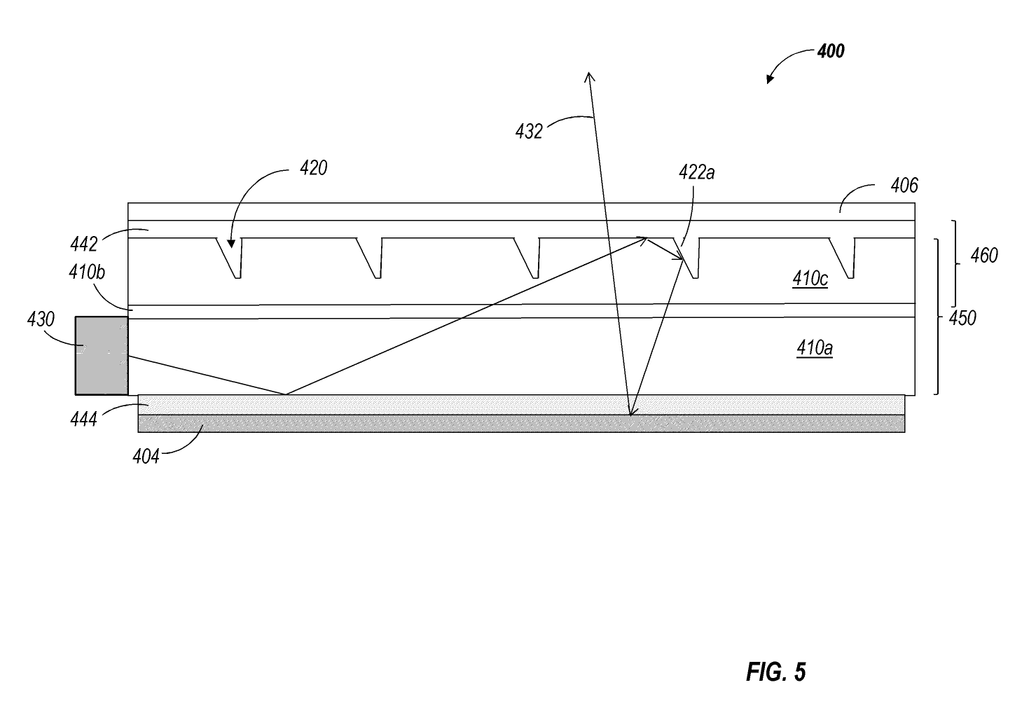

FIG. 5 is a cross-sectional view of a display device including a frontlight system which includes asymmetrical light-turning features. In the implementation of FIG. 5, the light-guiding layer 410 is a multilayer structure, including a display substrate 410a, a light-turning sublayer 410c in which the asymmetric light-turning features 420 are formed, and an optically clear adhesive 410b securing the display substrate 410a to the light-turning sublayer 410c.

In some implementations, the display substrate 410a may include glass, and may have a refractive index of roughly 1.53. The light-turning sublayer 410c is also formed from a high-index material, and may in some implementations be a layer of polycarbonate with an index of refraction of roughly 1.58. The light-turning sublayer 410c is also sufficiently thick that the asymmetrical light-turning features 420 can be formed therein, and may in some implementations be roughly 100 um thick. The adhesive layer 410b may be formed of an optically clear adhesive having an index of refraction between the indices of refraction of the display substrate 410a and the light-turning sublayer 410c, and may in some implementations have an index of refraction between about 1.53 and 1.55. Other materials, thicknesses, and arrangements of layers may also be used, however.

In implementations such as the display device 500 of FIG. 5, in which the display substrate 410a forms a part of the light-guiding layer 410, a low-index lower cladding layer 444 may be disposed between the display substrate 410a and a reflective display 404 supported by the display substrate 410a. In some implementations, the lower cladding layer 444 may be formed prior to the formation of an array of reflective display elements such as interferometric modulators (discussed in greater detail below) which form part of the reflective display 404. In some implementations, the lower cladding layer 444 can be a layer of spin-on glass with a refractive index of less than 1.39, although other materials may also be used.

An upper cladding layer 442 is formed over the light-turning sublayer 410c. In the illustrated implementation, as discussed above, the upper cladding layer may fill the light-turning features 420 in the upper surface of the light-turning sublayer 410c. In other implementations, upper cladding layer 442 may be a generally planar layer which overlies but does not fill the light-turning features 420, but residual air within the light-turning features 420 may cause undesirable optical effects under certain circumstances. In some implementations, as discussed in greater detail below, the light-turning sublayer 410c and upper cladding layer 442 may be a multilayer structure 460 formed as part of a roll-to-roll process or other manufacturing process, and adhered to the display substrate 410a. A protective cover 406 may be disposed over the upper cladding layer 406, and may in some implementations be a cover glass.

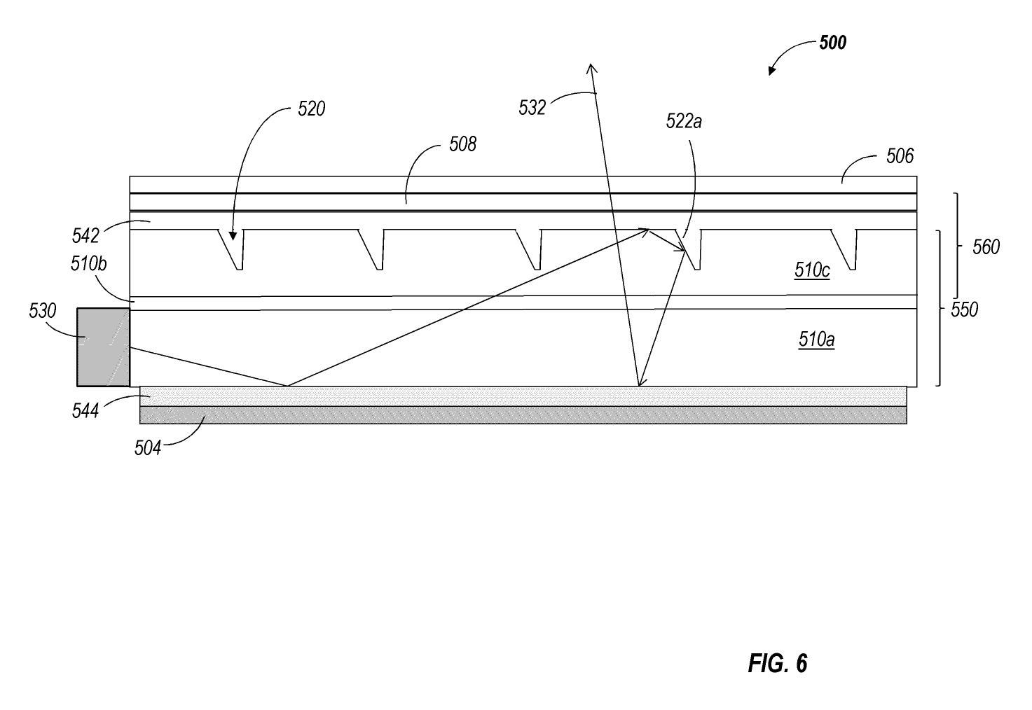

FIG. 6 is a cross-sectional view of an alternate implementation of a display device including a touch-sensing system as well as a frontlight system which includes asymmetrical light-turning features. The frontlight system 500 of FIG. 6 is similar to the frontlight system 400 of FIG. 5, except that the frontlight system 500 includes one or more layers of a touch system 508 disposed between the upper cladding layer 542 and the cover 506. The touch system 508 may include, for example, a grid or other arrangement of conductive electrodes or sensors, which may be formed from a transparent oxide such as indium-tin-oxide (ITO) or a conductive metal such as aluminum (Al). The touch system 508 may be part of a multilayer structure 570 which can be formed as part of a roll-to-roll process or other manufacturing process, and adhered to the display substrate 510a.

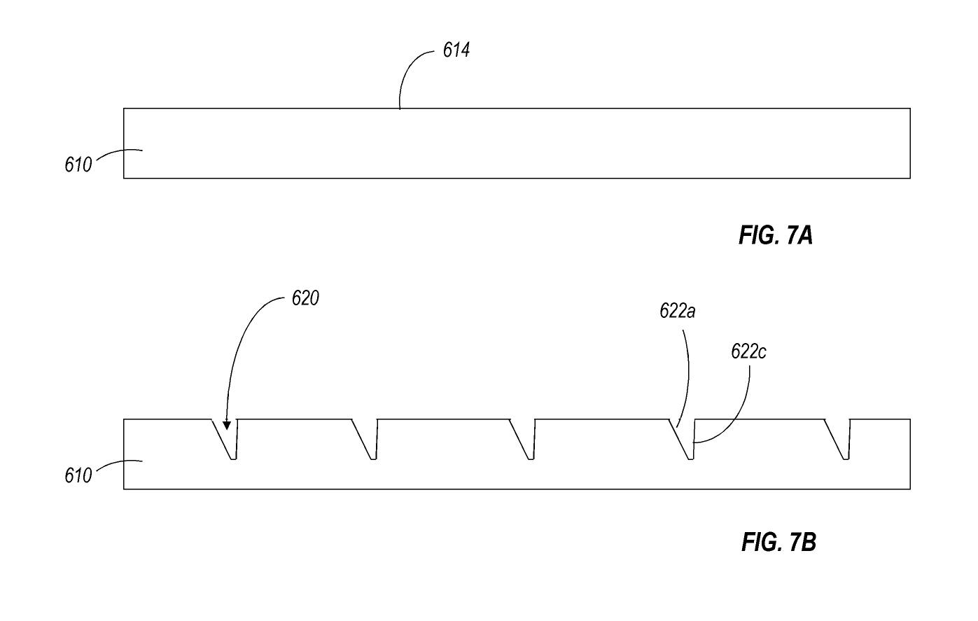

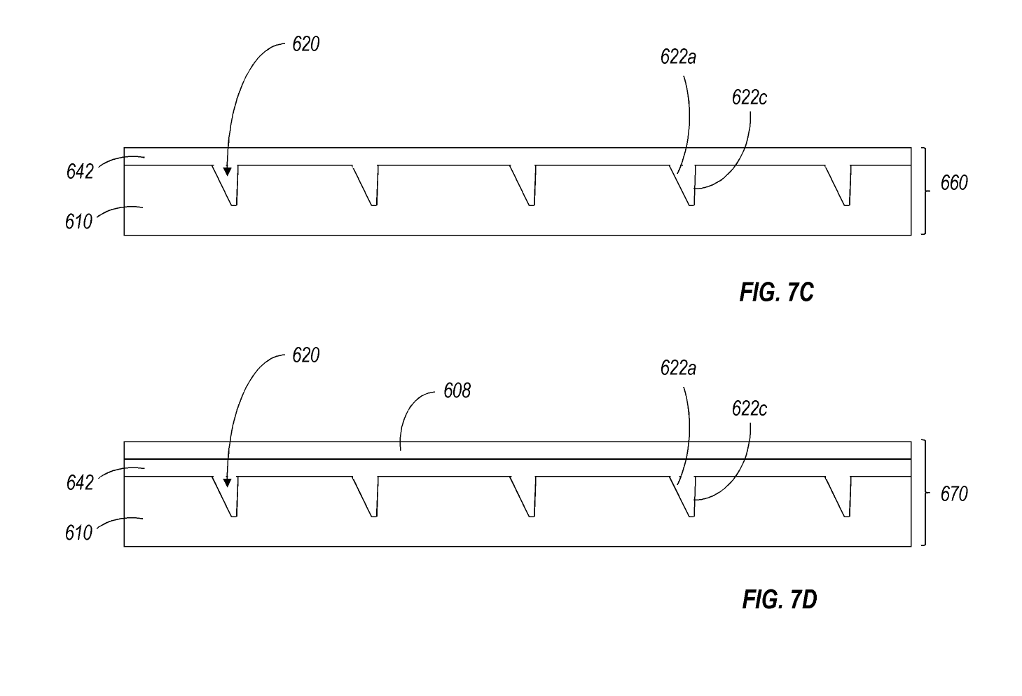

FIGS. 7A-7D illustrate various stages in a fabrication process for forming a multilayer structure including asymmetrical light-turning features. In FIG. 7A, a high-index film 610 is provided, which will be subsequently processed to form a light-turning film such as the light-turning film 410c of FIG. 5 or the light-turning film 510c of FIG. 6. In some implementations, the high-index film 610 will serve as a blank in an embossing or stamping process, as discussed in greater detail below. The high-index film 610 may be any high-index material or stack of materials which is susceptible to formation of light-turning features therein. As discussed above, the high-index film may in some implementations be a plastic film, and may in some particular implementations be a polycarbonate film roughly 100 um in thickness, although a wide variety of materials and thicknesses may also be used. In some implementations, the high-index film may be heated at this stage to facilitate later stamping.

In FIG. 7B, light-turning features 620 are formed in the upper surface 614 of the high-index film 610 to form a light-turning film. As discussed above, these light-turning features 620 are asymmetric, with the leading edges 622a angled relative to the upper planar surface 614 of the high-index film 610, and the trailing edges 622c almost vertical and almost aligned with the normal of the upper surface 614 of the high-index film 610. These light-turning features 620 are also generally aligned with one another, with the leading edges 622a either pointing in the same direction, or turned slightly so that the leading edges 622a point towards a specific point or area.

In some implementations, as discussed above, the light-turning features 620 can be formed by a stamping or embossing process using a metal mold or other sufficiently rigid mold. The metal mold can be made by, for example, forming the shape of an original light-turning film in photoresist or any other patternable material. Grayscale laser lithography or grayscale e-beam lithography techniques can be used to achieve the necessary precision, although a wide variety of other processing techniques can also be used. An electroplating technique can be used to form a master mold including the inverse of the light-turning features as raised asymmetrical frusta, and the photoresist or other original material may be removed. The mold may then be applied to a roll and used as part of a roll-to-roll embossing or stamping process. Depending on the size of the embossing or stamping roll, multiple metal molds can be used to provide high manufacturing throughput.

In FIG. 7C, a low-index cladding layer 642 is formed over the upper surface 614 of the high-index film 610. In some implementations, this low-index cladding layer 642 fills the light-turning features 620 formed in the high-index film 610. The low-index cladding layer 642 may in some implementations be an optically clear resin (OCR) and have an index of refraction of roughly 1.33. The low-index cladding layer 642 may also be applied as part of a roll-to-roll process, with the low-index cladding layer 642 applied via a second or subsequent roll after the stamping process which forms the light-turning features 620. The deformable nature of the resin can facilitate the filling of the light-turning features 620 formed in the high-index film 610, along with pressure applied during the roll-to-roll fabrication process.

The resulting multilayer structure 660 can be used as part of a frontlight system. In some implementations, the multilayer structure 660 can be laminated to or otherwise adhered to another high-index substrate, such as display substrate 410a of FIG. 5 or the display substrate 510a of FIG. 6. A generally index-matched optically clear adhesive can be used to secure the multilayer structure 660 to the other high-index substrate, and a low-index cladding layer can be disposed on the opposite side of the high-index substrate to allow light to propagate within the high-index layers due to total internal reflection. In other implementations, the multilayer structure 660 could also include a low-index cladding layer, which could be applied to a lower surface of the high-index film 610. In such an implementation, the multilayer structure 660 could serve as part of a self-contained frontlight system, which could be applied to any suitable device or object.

In some implementations, an antireflective coating may also be applied prior to the application of the low-index cladding layer 642, such that the antireflective coating is disposed along the boundary between the low-index cladding layer 642 and the high-index film 610. One example of a suitable antireflective coating is a layer of silicon oxide (SiO₂). In some implementations, the antireflective coating may be a layer of SiO₂ roughly 90 nm thick, although a wide variety of other thicknesses and materials may also be used.

In some implementations, a touch sensor array may also be formed and applied via a roll-to-roll process. In FIG. 7D, a touch system 608 is applied over the low-index cladding layer 642. The touch system 608 may be a multilayer structure formed separately and applied via a roll-to-roll process, or may be a series of individual layers applied consecutively via a roll-to-roll process. The touch system 608 may include a crisscrossing grid of electrodes, or any other suitable touch-sensing system. The multilayer structure 670 may be laminated to or otherwise adhered to another high-index substrate, such as display substrate 410a of FIG. 5 or the display substrate 510a of FIG. 6, in order to provide both light-turning features and components of a touch sensor array. Alternately, a low-index cladding layer could be applied to a lower surface of the high-index film 610 to provide a multilayer structure 670, which could serve as self-contained components of a frontlight system and touch system. Such a system could be applied to any suitable device or object.

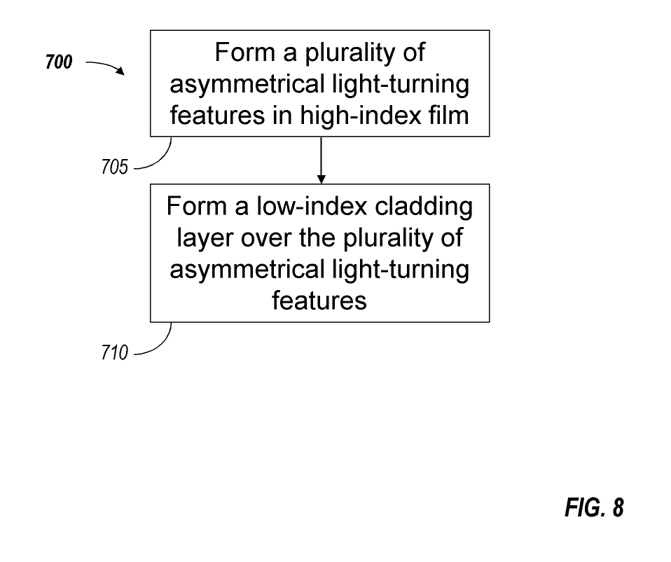

FIG. 8 is a flow diagram illustrating a fabrication process for a multilayer structure including asymmetrical light-turning features. In block 705 of the fabrication process 700, a plurality of asymmetrical light-turning features are formed in a high-index film. As discussed above, the high-index film can be a plastic film such as a polycarbonate, and the asymmetrical light-turning features can be embossed or stamped into the high-index film using a roll-to-roll process or similar fabrication process. The asymmetrical light-turning features can include a leading edge configured to turn light out of the high-index film, and a trailing edge which is near vertical in order to increase recapture of light leaking out of the film.

In block 710 of the fabrication process 700, a low-index cladding layer is applied over the plurality of asymmetrical light-turning features. The low-index cladding layer can applied so as to fill the plurality of asymmetrical light-turning features. In some implementations, the low index cladding layer can be an optically clear resin, although other materials may also be used. The low-index cladding layer may also be applied as part of a roll-to-roll process.

As noted above, an antireflective coating can in some implementations be applied prior to the application of the low-index cladding layer. Additional layers, including touch systems, may be applied after application of the low-index cladding layer. The multilayer structure may then be adhered to a display substrate to form part of a frontlight system, or an additional low-index cladding layer can be applied on the opposite side of the high-index film as the first low-index cladding layer, in order to form a self-contained light-turning component of a frontlight system.

The above implementations of frontlight systems and components may be used to illuminate a wide variety of objects, including but not limited to reflective displays. One non-limiting example of a reflective display type with which the frontlight systems and components described herein may be used is an interferometric modulator (IMOD) based display.

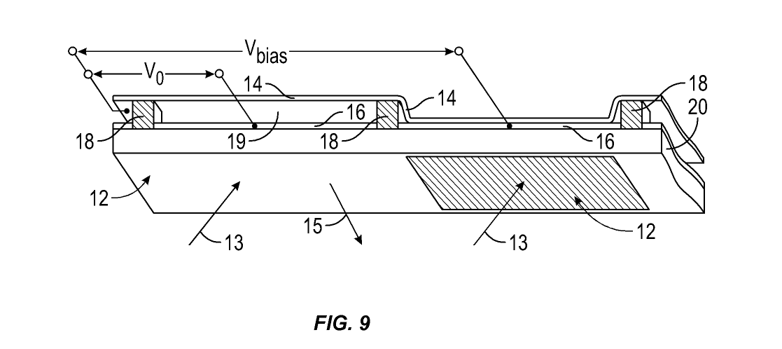

FIG. 9 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 9 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 9, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 9 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 9, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 9. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

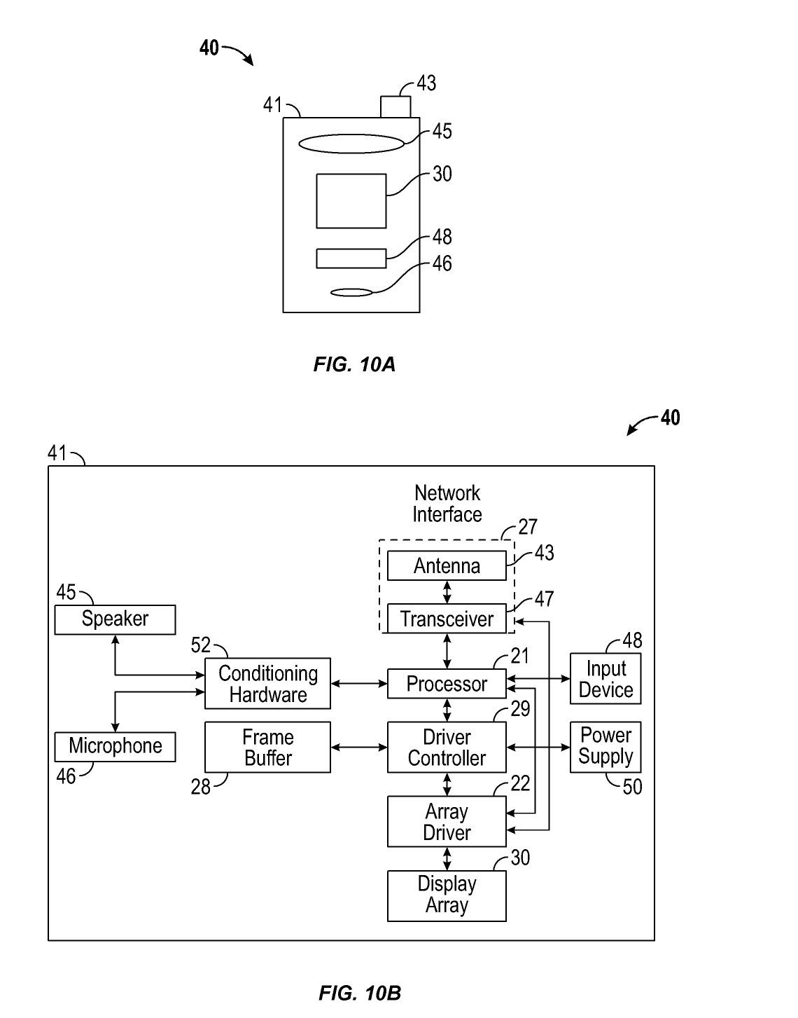

FIGS. 10A and 10B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 10A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A light-turning structure comprising:
a substrate including a first generally planar surface and a second generally planar surface; and
a plurality of depressions in the shape of asymmetrical frusta formed in the first surface of the substrate, each of the plurality of depressions having an angled sidewall including:
a leading edge forming a first angle relative to a normal of the first surface and configured to reflect a portion of incident light out of the substrate, and
a trailing edge forming a second angle relative to the normal of the first surface, wherein the first angle is substantially larger than the second angle.

2. The structure of claim 1, wherein the first angle is between 31° and 35°.

3. The structure of claim 1, wherein the second angle is between 1° and 5°.

4. The structure of claim 1, wherein the plurality of depressions have an ellipsoidal cross-section.

5. The structure of claim 1, wherein each of the plurality of depressions includes an ellipsoidal opening in the first surface of the light substrate and an ellipsoidal base, wherein the ellipsoidal opening is non-concentric with the ellipsoidal base.

6. The structure of claim 1, wherein the substrate includes a first material, the structure additionally including a cladding layer formed over the first surface of the substrate, wherein the cladding layer is formed from a second material, and wherein the index of refraction of the first material is greater than the index of refraction of the second material.

7. The structure of claim 6, wherein the cladding layer fills the plurality of depressions.

8. The structure of claim 6, wherein the second material is an optically clear resin.

9. The structure of claim 6, additionally including an antireflection coating disposed between the substrate and the cladding layer.

10. The structure of claim 1, additionally including a second substrate sealed to the second surface of the first substrate via an optically clear adhesive, wherein each of the first substrate, the second substrate, and the optically clear adhesive include materials having similar indices of refraction.

11. The structure of claim 1, wherein the substrate includes a first edge, and wherein the leading edges of the angled sidewalls of the plurality of depressions are generally aligned to face the first edge of the substrate.

12. The structure of claim 11, wherein a density of the plurality of depressions increases with increasing distance from the first edge of the substrate.

13. A reflective display device, comprising:
an array of reflective display elements; and
a frontlight system configured to illuminate the array of reflective display elements, the frontlight system including:
a light-guiding layer having a first edge, a first generally planar surface, and a second generally planar surface;
a light source configured to inject light into the light-guiding layer through the first edge of the light-guiding layer; and
a plurality of light-turning features in the shape of asymmetrical frusta formed in the first surface of the light-guiding layer and configured to reflect light out of the light-guiding layer through the second surface of the light-guiding layer and towards the array of reflective display elements.

14. The device of claim 13, wherein each of the plurality of depressions has an angled sidewall including:
a leading edge forming a first angle relative to a normal of the first surface of the light-guiding layer, and
a trailing edge forming a second angle relative to the normal of the first surface, wherein the first angle is substantially larger than the second angle.

15. The device of claim 14, wherein the first angle is between 31° and 35°, and wherein the second angle is between 1° and 5°.

16. The device of claim 13, wherein each of the plurality of depressions includes an ellipsoidal opening in the first surface of the light-guiding layer and an ellipsoidal base, wherein the ellipsoidal opening is non-concentric with the ellipsoidal base.

17. The device of claim 13, additionally including a first cladding layer disposed between the light-guiding layer and the array of reflective display elements and a second cladding layer disposed on the opposite side of the light-guiding layer as the first cladding layer, wherein the indices of refraction of the first and second cladding layers are lower than the index of refraction of the light-guiding layer.

18. The device of claim 17, additionally including an array of touch sensors disposed on the opposite side of the second cladding layer as the light-guiding layer.

19. The device of claim 13, additionally including:
a processor that is configured to communicate with the array of reflective display elements, the processor being configured to process image data; and
a memory device that is configured to communicate with the processor.

20. The device of claim 19, additionally including:
a driver circuit configured to send at least one signal to the array of reflective display elements; and
a controller configured to send at least a portion of the image data to the driver circuit.

21. The device of claim 19, additionally including an image source module configured to send the image data to the processor, wherein the image source module comprises at least one of a receiver, transceiver, and transmitter.

22. The device of claim 19, additionally including an input device configured to receive input data and to communicate the input data to the processor.

23. A light-turning structure comprising:
a substrate including a first generally planar surface and a second generally planar surface; and
means for reflecting a portion of incident light out of the substrate, wherein the amount of incident light reflected out of the substrate varies depending on the direction of incidence upon the reflecting means.

24. The structure of claim 23, wherein the reflecting means include:
a plurality of depressions in the shape of asymmetrical frusta formed in the first surface of the substrate, each of the plurality of depressions having an angled sidewall including:
a leading edge forming a first angle relative to a normal of the first surface and configured to reflect a portion of incident light out of the substrate, and
a trailing edge forming a second angle relative to the normal of the first surface, wherein the first angle is substantially larger than the second angle.

25. The structure of claim 24, wherein the first angle is between 31° and 35°, and wherein the second angle is between 1° and 5°.

26. The structure of claim 24, wherein the substrate includes a first material, the structure additionally including a cladding layer formed over the first surface of the substrate, wherein the cladding layer is formed from a second material, and wherein the index of refraction of the first material is greater than the index of refraction of the second material.

27. A method of fabricating a light-turning structure, comprising:
embossing a plurality of depressions in the shape of asymmetrical frusta into a first generally planar surface of a substrate, the substrate including a first material having a first index of refraction; and
applying a cladding layer over the first surface of the substrate after embossing the plurality of depressions into the substrate, the cladding layer including a second material having a second index of refraction smaller than the first index of refraction.

28. The method of claim 27, wherein each of the depressions have an angled sidewall including:
a leading edge forming a first angle relative to the normal of the first surface and configured to reflect a portion of incident light out of the substrate, and
a trailing edge forming a second angle relative to the normal of the first surface, wherein the first angle is substantially larger than the second angle.

29. The method of claim 27, wherein embossing a plurality of depressions and applying a cladding layer are performed as part of a roll-to-roll fabrication process.

30. The method of claim 27, additionally including depositing an antireflection coating over the embossed first surface of the substrate prior to application of the cladding layer.
